(19) United States
(12) Patent Application Publication
(10) Pub. No.: US 2026/0205363 A1
(43) Pub. Date: Jul. 16, 2026

(54) SYSTEM AND METHOD FOR PERFORMING A COMMUNICATION SESSION TRACE USING NETWORK ELEMENT NAMES

(71) Applicant: BOOST SUBSCRIBERCO L.L.C., Englewood, CO (US)

(72) Inventors: Kameswara Achyuth Kumar Kala, Highlands Ranch, CO (US); ShashiKiran Sureshbabu, Highlands Ranch, CO (US); Abhishek Jayprakash Shirke, Aurora, CO (US); Jaya Chandra Chikatmarla, Highlands Ranch, CO (US); Ramakrishna M Mudumby, Littleton, CO (US); Prakash Kumar M Patel, Castle Rock, CO (US); Mohammad Dawood Shahdad, Aurora, CO (US); Simhadri Podala Narasimha, Littleton, CO (US)

(21) Appl. No.: 19/025,583

(22) Filed: Jan. 16, 2025

(51) Int. Cl. H04L 41/12; H04L 43/06; H04L 43/12

(52) U.S. Cl. CPC H04L 41/12; H04L 43/06; H04L 43/12

(57) ABSTRACT

A method for performing a communication session trace using network element names includes establishing, using a processor device, a communication session trace with one or more network elements of a communication network, collecting, using the processor device, trace data from the one or more network elements of the communication network associated with the communication network trace, identifying, using the processor device, a network element name for each network element in the trace data, and generating, using the processor device, a report comprising the trace data including the network element name for each network element.

### BACKGROUND

Wireless communication networks that transport digital data and telephone calls are becoming increasingly sophisticated. Currently, fifth generation (5G) broadband cellular networks are being deployed around the world. These 5G networks use emerging technologies to support data and voice communications with millions, if not billions, of mobile phones, computers and other devices. 5G technologies are capable of supplying much greater bandwidths than was previously available.

### SUMMARY

In accordance with an embodiment, a system for performing a communication session trace using network element names includes a memory that stored one or more computer readable media that includes instructions and one or more processor devices configured to execute the instructions of the computer readable media to establish a communication session trace with one or more network elements of a communication network, collect trace data from the one or more network elements of the communication network associated with the communication network trace, identify a network element name for each network element in the trace data, and generate a report comprising the trace data including the network element name for each network element.

In accordance with another embodiment, a method for performing a communication session trace using network element names includes establishing, using a processor device, a communication session trace with one or more network elements of a communication network, collecting, using the processor device, trace data from the one or more network elements of the communication network associated with the communication network trace, identifying, using the processor device, a network element name for each network element in the trace data, and generating, using the processor device, a report comprising the trace data including the network element name for each network element.

In accordance with yet another embodiment, a non-transitory, computer-readable medium storing instructions that, when executed by a processor perform a set of functions for performing a communication session trace using network element names. The set of functions include establishing a communication session trace with one or more network elements of a communication network, collecting trace data from the one or more network elements of the communication network associated with the communication network trace, identifying a network element name for each network element in the trace data, and generating a report comprising the trace data including the network element name for each network element.

### BRIEF DESCRIPTION OF THE DRAWINGS

The present disclosure will hereafter be described with reference to the accompanying drawings, wherein like reference numerals denote like elements.

FIG. 1 is a schematic block diagram of an example communication network in accordance with an embodiment;

FIG. 2 is a schematic block diagram of an example of a service-based architecture of a communication network in accordance with an embodiment;

FIG. 3 is a block diagram of a system for performing a communication session trace using network element names in accordance with an embodiment;

FIG. 4 illustrates a method for performing a communication session trace using network element names in accordance with an embodiment;

FIG. 5 illustrates an example report with trace data and network element names in accordance with an embodiment; and

FIG. 6 is a schematic block diagram of an example computer system in accordance with an embodiment.

### DETAILED DESCRIPTION

A plurality of hardware and software-based devices, as well as a plurality of different structural components can be used to implement the disclosed technology. In addition, examples of the disclosed technology can include hardware, software, and electronic components or modules that, for purposes of discussion, can be illustrated and described as if the majority of the components were implemented solely in hardware. However, in at least one example, the electronic based aspects of the disclosed technology can be implemented in software (for example, stored on non-transitory computer-readable medium) executable by one or more electronic processors. Although certain drawings illustrate hardware and software located within particular devices, these depictions are for illustrative purposes only. In some examples, the illustrated components can be combined or divided into separate software, firmware, hardware, or combinations thereof. As one example, instead of being located within and performed by a single electronic processor, logic and processing can be distributed among multiple electronic processors. Regardless of how they are combined or divided, hardware and software components can be located on the same computer device or can be distributed among different computing devices connected by one or more networks or other suitable communication links.

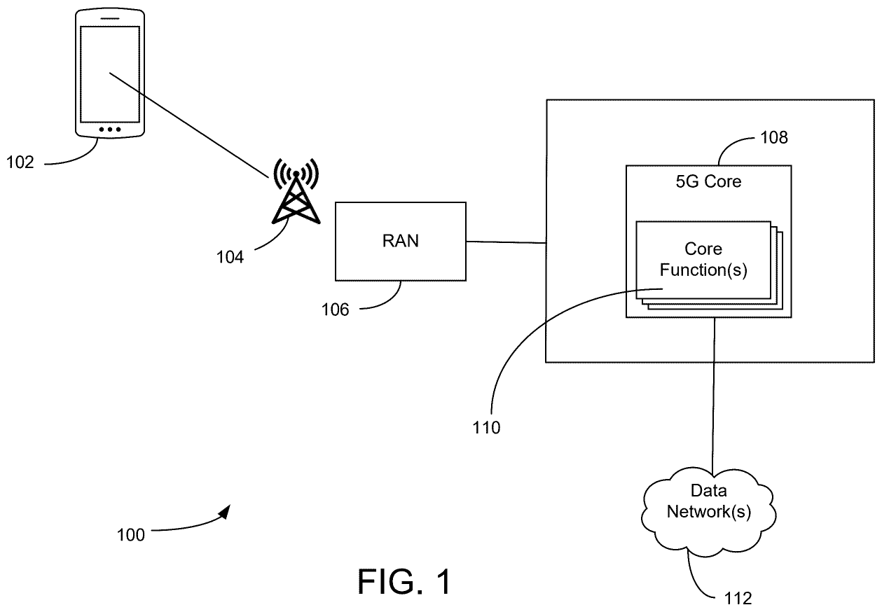

FIG. 1 is a schematic block diagram of an example communication network in accordance with an embodiment. The communication network 100 can include a user equipment (UE) device 102, a radio access network (RAN) 106, and a 5G core 108. The RAN 106 and 5G core 108 can enable the UE device 102 to, for example, communicate with other UE devices and to communicate with one or more external data networks (DNs) 112 (e.g., the Internet or a private corporate network) using the RAN 106 and 5G core 108. For example, if the external data network 112 is the Internet, the RAN 106 and 5G core 108 can allow the UE device 102 to send and receive data via the Internet. While FIG. 1 illustrates various components of communication network 100, other embodiments of communication network 100 can vary the arrangement, communication paths, and specific components of communication network 100. In some embodiments, the wireless communication network 100 can include fewer, additional, or different components in different configurations than illustrated in FIG. 1. For example, in some embodiments, the wireless communication network 100 may include additional or different UE devices 102.

The communication network 100 may be used to facilitate multiple types of communication sessions, such as, for example, voice calls, video calls, messaging, data transmission, and/or other types of communications. In some embodiments, the communication network 100 can be configured to implement IP multimedia services or subsystems (IMS) for delivering multimedia communication services such as, for example, voice, video, and text messaging over IP networks. The communication network 100 may represent a portion of a wireless network built around 5G (fifth generation) standards promulgated by standards setting organizations under the umbrella of the Third Generation Partnership Project (3GPP). Accordingly, in some configurations, the communication network 100 may be a 5G network, such as, for example, a 5G cellular network. Such 5G networks, including the communication network 100, may comply with industry standards, such as, for example, the Open Radio Access Network (Open RAN or O-RAN) standard that describes interactions between the network and user equipment (e.g., mobile phones and the like). The O-RAN model follows a virtualized model for a 5G wireless architecture in which 5G base stations (gNBs) are implemented using separate centralized units (CUs), distributed units (DUs), and radio units (RUs). In some configurations, O-RAN CUs and DUs may be implemented using software modules executed by distributed (e.g., cloud) computing hardware. Virtualization allows for various other components of the cellular network, such as cellular network core functions, to be implemented as code that is executed using general-purpose computer resources. Such general purpose computing resources can be part of a public cloud-computing platform that provides virtual private clouds (VPCs) for multiple clients. On a hybrid cellular network, RAN components of the cellular network are in communication with components of the cellular network executed on a public cloud computing platform such as Amazon Web Services (AWS).

In some configurations, the communication network 100 may be a standalone (SA) network (e.g., a 5G SA network) that utilizes 5G cells for both signaling and information transfer via a 5G packet core architecture. In other configurations, the communication network 100 may be a non-standalone (NSA) network that depends on another network, such as, for example, a control plane of a fourth generation (4G) long-term evolution (LTE) network.

As mentioned, in some embodiments, the UE device 102 can transmit data from one or more applications on the UE device 102 to an external data network (DN) 112, for example, the Internet, via the communication network 100. While FIG. 1 illustrates one UE device 102, in some embodiments, it should be understood that the communication network 100 can support a plurality of UE devices 102. UE device 102 can be various forms of wireless devices that are capable of communication according to the radio access technology (RAT) of the communication network 100 (e.g., a 5G new radio (NR) network). For example, in some embodiments, the UE device 102 can be a smartphone, a wireless modem, a cellular phone, a laptop computer, a wireless access point (AP), etc.

After the UE device 102 has established a connection or session with the RAN 106, the communication network 100 can provide data (e.g., data packets) to the UE device 102 and can receive data from the UE device 102. In some embodiments, the data can include, for example, voice data for a phone call, data provided by a web server to the UE device 102, data provided by the UE device 102 to a Web server, or other types of data commonly exchanged on communication networks. For example, after the UE device 102 has established a connection or session with the RAN 106, a user of the UE device 102 may select to stream a video on an application of the UE device 102 via the Internet (e.g., data network 112). The video stream can be provided to the UE device 102 on data packets.

The UE device 102 can communicate with the RAN 106 in various ways, such as, for example, via a radio transceiver 104, which may also be referred to as a radio unit (RU) in the O-RAN architecture. The RAN 106 may be or include a disaggregated RAN (referred to as an Open RAN or O-RAN) which can include hierarchy (e.g., tree structure) of RAN functions. In such examples, the RAN 106 may include one or more CUs and one or more DUs. For example, each of multiple CUs may be coupled with multiple DU, and each DU may be coupled with multiple RUs (e.g., the radio transceiver 104). As such, each UE device 102 can communicate with backhaul network infrastructure (e.g., a 5G Core 108) according to an assigned communication path through a particular RU, DU, and CU. An RU (e.g., the radio transceiver 104) in combination with a DU and CU may be referred to as a gNodeB (gNB) in the O-RAN architecture. Such a gNB may be a 3GPP 5G next generation base station that supports communications with the with the UE device 102. While FIG. 1 illustrates a single radio transceiver 104 and a single RAN 106, in practical implementations the communication network 100 may include any number of radio transceivers 104 and/or any number of RAN 106.

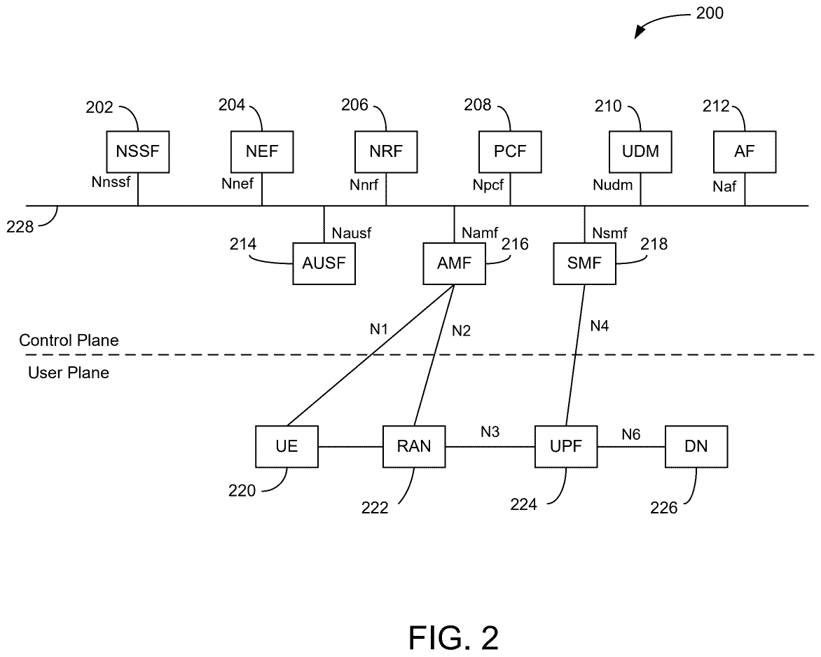

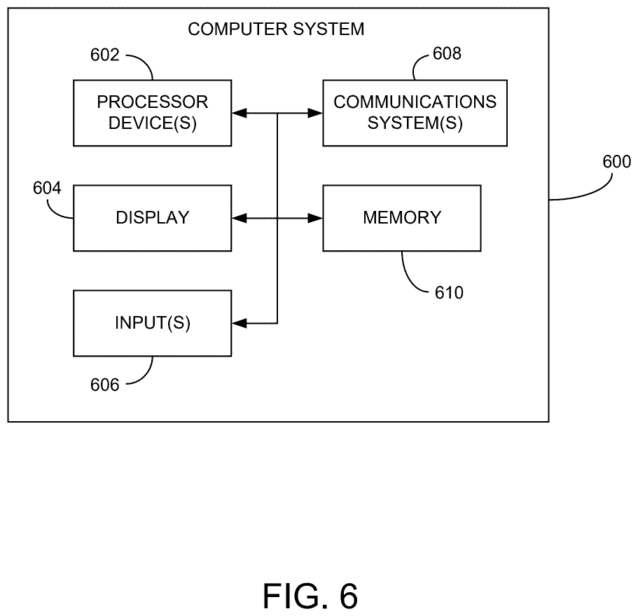

The 5G Core 108 may include one or more core functions 110. Each core function 110 can be a network function (NF) that provides a utility or service specific to the 5G core 108, for example, core functions of the communication network 100. In some embodiments, for example, different NFs may provide different utility to the communication network 100. In some embodiments, the 5G core 108 including the core functions 110 can reside on a cloud computing platform. For example, in some embodiments, the communication network (e.g., communication network 100), or portion thereof, in which the 5G core 108 is implemented may be disaggregated, such that, for example, NFs may be developed or operated by multiple vendors or operators. In some embodiments, an NF may be virtualized. An NF may be virtualized by implementing the NF in a cloud-native architecture. Accordingly, in some embodiments, an NF may be a cloud-native NF (CNF). A CNF may refer to a service (or utility) that performs network duties in software (e.g., as opposed to purpose-built hardware). Examples of various core functions 110 are discussed further below with respect to FIG. 2. In some embodiments, the RAN 106 and the 5G core 108 (including core functions 110) may be implemented on a computer system (e.g., computer system 600 discussed below with respect to FIG. 6) such as a server or the functionality of the RAN 106, the 5G core 109 and core functions 110 may be distributed among multiple servers or devices (e.g., as part of a cloud service or cloud-computing environment). In some embodiments, the 5G core 108 can be physically distributed across data centers or located at a central national data center (NDC) (e.g., the 5G core can logically reside as part of an NDC, for example, in a region-based network topology (discussed further below). Within an NDC, multiple regional data centers (RDCs) can be logically present. In some embodiments, each of such one or more regional data centers may execute core functions 110 for a different geographic region or a group of RAN components.

As mentioned, in some embodiments, the communication network 100 can be configured according to a region-based topology. For example, the communication network 100 may be implemented using a cloud computing platform that is logically and physically divided up into various different cloud computing regions (e.g., AWS regions). The cloud computing regions may be based on geographical location of the gNbs; for example, the communication network 100 for a given nation may be divided into a number of geographical regions. Each of the cloud computing regions can be isolated from other cloud computing regions to help provide fault tolerance, fail-over load-balancing, and/or stability and each of the cloud computing regions can be composed of multiple availability zones (AZs) or markets, each of which can be a separate data center located in general proximity to each other (e.g., within 100 miles). For example, one cloud computing region may have its data centers and hardware located in the northeast of the United States while another cloud computing region may have its data centers and hardware located in California. Each of the availability zones may be a discrete data center or group of data centers that allows for redundancy, thereby to provide fail-over protection from other availability zones within the same cloud computing region. For example, when a particular data center of an availability zone experiences an outage, another data center of the availability zone or separate availability zone within the same cloud computing region can continue functioning and providing service.

FIG. 2 is a schematic block diagram of an example of a service-based architecture (SBA) of a communication network in accordance with an embodiment. The SBA 200 is divided between a control plane and a user plane. The control plane includes a plurality of network functions (NFs) 202-218. The user plane includes a UE 220 (e.g., UE 102 shown in FIG. 1) in communication with a RAN 222, and NFs (e.g., UPF 224). In FIG. 2, the SBA 200 can be used for providing communication between the UE device 220 and a data network 226 (e.g., the Internet). In FIG. 2, the example 5G core is simplified to show some key components, however, implementations can involve additional components. In some embodiments, the communication network (e.g., communication network 100 shown in FIG. 1), or portion thereof, in which the 5G core is implemented may be disaggregated, such that, for example, NFs may be developed or operated by multiple vendors or operators. In some embodiments, an NF may be virtualized. An NF may be virtualized by implementing the NF in a cloud-native architecture. Accordingly, in some embodiments, an NF may be a cloud-native NF (CNF). A CNF may refer to a service (or utility) that performs network duties in software (e.g., as opposed to purpose-built hardware). For ease of illustration, FIG. 2 only shows a single UE 220 being connected to the RAN 222, however, in practical implementations any number of UEs 220 can be present, limited only by the capacity of the network.

In the example architecture illustrated in FIG. 2, the NFs can include a Network Slice Selection Function (NSSF) 202, a Network Exposure Function (NEF) 204, a Network Repository Function (NRF) 206, a policy control function (PCF) 208, a Unified Data Management (UDM) function 210, an Application Function (AF) 212, an Authentication Server Function (AUSF) 214, an Access and Mobility Management Function (AMF) 216, a Session Management Function (SMF) 218, and a User Plane Function (UPF) 224. The NSSF 202 can provide tailor made logical networks on the physical network, for example, the NSSF can be used by the AMF 216 to assist with the selection of a network slice that will serve a particular UE device. The NEF 204 can expose services and resources over application programming interfaces (APIs) within and outside the 5G core. The NRF 206 can enable 5G network functions (NFs) to register and discover each other via a standards-based application programming interface (API). The PCF 208 can apply session policies for the UE device 220, or other devices, when connecting over, for example, 5G. The UDM 210 can manage network user data in a single, centralized element and can allow for generation of authentication vectors, user identification handling, NF registration management, and retrieval of UE device individual subscription data for slice selection. The AF 212 can interact with the 3GPP Core Network in order to provide services, for example, to support one or more of application function influence on traffic routing, application function influence on service function chaining, accessing the NRF 212, interacting with the PCF 216, time synchronization service, IP multimedia subsystem (IMS) interactions with the 5G core, or packet data unit (PDU) set handling. The AUSF 214 can allow the AMF 216 to authenticate the UE and access services of the 5G core. The AMF 216 can perform operations like mobility management, registration management, connection management, UE-based authentication, etc. The SMF 218 can interact with the decoupled data plane, can perform internet protocol (IP) address allocation and management for UE devices (e.g., UE device 220), user plane selection, and packet routing in conjunction with the UPF 224, etc. The UPF 224 can perform user plane operations, such as maintaining protocol data unit (PDU) sessions, packet routing and forwarding, inspection policy enforcement for the user plane, Quality of Service (QoS) handling, providing data access to the UE 220, etc. A PDU session can provide connectivity between applications on the UE device 220 and the DN 226 (e.g., the Internet). The SMF 218 can also be responsible for creating, updating, and removing PDU sessions, selecting particular UPFs 224 on which to anchor PDU sessions when new UE devices 220 appear on the communication network, and managing session context with the UPF 224. Together with the UPF 224, the SMF 218 can maintain a record of PDU session state by means of a PDU Session ID.

The SBA 200 may also include a plurality service-based interfaces (SBIs) 228 to provide access to or communicate with the various NFs. As illustrated, such service-based interfaces may include an Nnssf interface for the NSSF 202, an Nnef interface for the NEF 204, an Nnrf interface for the NRF 206, an Npcf interface for the PCF 208, an Nudm interface for the UDM 210, an Naf interface for the AF 212, an Nausf interface for the AUSF 214, an Namf interface for the AMF 216, and an Nsmf interface for the SMF 218. In some embodiments, the UE 220 can communicate with the RAN 222 wirelessly, for example, via a radio transceiver 104 (shown in FIG. 1). The AMF 216 and the UE 220 can communicate signals or messages with another over, for example, an N1 interface. The AMF 216 and the RAN 222 can communicate signals or messages with one another over, for example, an N2 interface. The RAN 222 and the UPF 224 can communicate signals and data with one another over, for example, an N3 interface. The SMF 218 and the UPF 224 can communicate signals or messages with one another over, for example, an N4 interface. The UPF 224 can send and receive signals and data with the Internet 226 over an Internet interface, for example, an N6 interface. The AMF 216 and the SMF 218 can communicate signals and messages with one another over an interface, for example, an N11 interface.

The above-listed NFs and interfaces are intended to be illustrative and not exhaustive. In practical implementations, the SBA 200 may include additional NFs and other network entities, such as an SNPN Authentication and Authorization Function (NSSAAF), a Network Data Analytics Function (NWDAF), a United Data Repository (UDR), a 5G-Equipment Identity Register (5G-EIR), a Charging Function (CHF), a Service Communication Proxy (SCP), a Security Edge Protection Proxy (SEPP), a Hone Subscriber Service (HSS), a Home Location Register (HLR), a Binding Support Function (BSF), a Policy and Charging Rules Function (PCRF), a Call Session Control Function (CSCF), a Session Border Control Function (SBC), a Media Resource Function (MRF), a Short Message Service Function (SMSF), a Rich Communication Services Application (RCS), an Authentication, Authorization, and Accounting (AAA) service, or a Diameter Routing Agent (DRA).

In a communication network, such as a 5G network, an Internet Protocol (IP) address is a numerical identifier that is assigned to various network elements in the communication network. A network element can include, for example, a network function (e.g., the network functions described above with respect to FIG. 2), a network interface (e.g., the interfaces discussed above with respect to FIG. 2), or another component or element included in the communication network (e.g., communication network 100 shown in FIG. 1). The IP address uniquely identifies each network element. Accordingly, an IP address for any network element differs from the IP address for any other network element. By uniquely identifying each device and network function on the network, IP addresses can facilitate data communication between network elements. Examples of types of IP address formats can include, but are not limited to, Internet Protocol version 4 (IPv4 ) which expresses IP addresses as four sets of numbers separated by periods (e.g., 196.154.0.1) and Internet Protocol version 6 (IPv6 ) which expresses IP addresses as eight sets of numbers separated by colons (e.g., 2007:0db3:63a3:0000:0000:4b3e:0271:6445).

In a communication network, such as, for example, communication network 100 (shown in FIG. 1), it may be necessary to perform tracing of communication sessions (e.g., a call trace). Due to the complexity of communication networks (e.g., cellular 5G networks), if end users (or subscribers) are having difficulty with a communication session (e.g., for voice or data communication services) such as, for example, difficulty making or receiving a phone call, an investigation may need to be performed into the issue to determine if a problem lies within the handling of the communication session k within the network core (e.g., 5G core 108 shown in FIG. 1). There are many places within the core 108 where a communication session (e.g., a call, messaging, data transmission, other services, etc.) could be dropped or negatively affected. Tracing allows data such as communications (e.g., signaling messages) between communication network core components (e.g., the network functions, interfaces) to be gathered, output, and analyzed. Within the core 108 of the communication network 100, a particular network function (or component of the network function) may be instantiated many times over, for example in different regions, different availability zones, different region data centers, etc. A communication session trace can be acquired using, for example, a probing solution (or cloud probing solution) that can be used to monitor and collect data for analysis.

Each network element (e.g., network functions, network interfaces) can have an associated network element name (or hostname) in addition to a unique IP address. However, the trace data collected with a trace only provides the IP address of a network element utilized in sending (source) or receiving (destination) a particular signaling message. It can be difficult and time consuming for a network administrator or operator reviewing a communication session trace to identify and recognize the network elements involved in a communication session (e.g., what network element is sending or receiving a message) based on the IP address alone. Resolution of an issue may only be possible when the network element name (e.g., a host name) is known. This can be especially difficult when a communication session involves one or more network elements associated with communication networks of different communication service providers (CSPs).

The present disclosure describes systems and methods for performing a communication session trace using network element names. A tracing module can be configured to identify a network element name associated with an IP address in a communication session. Accordingly, the IP address can be mapped to the network element name (or hostname) and used by the tracing module to generate a report that includes the network element name for each network element in the trace data collected by a trace. In some embodiments, signaling messages collected with the trace can be configured to include the network element name within a packet in addition to the IP address assigned to the network element to facilitate decoding and troubleshooting. In some embodiments, a network element name (or hostname) database may be provided that includes both IP addresses and network element names for the network elements in one or more communication networks (e.g., different communication networks that are associated with different CSPs). The tracing module can be configured to access the network element name database to search for an IP address of a network element provided in trace data and identify the associated network element name for the network element. The described system and methods can advantageously increase efficiency, enhance the identification and recognition of network elements, simplify the management and configuration of network elements, and can improve Quality of Service (QoS) metrics be enabling faster and more precise identification of network elements within a communication network.

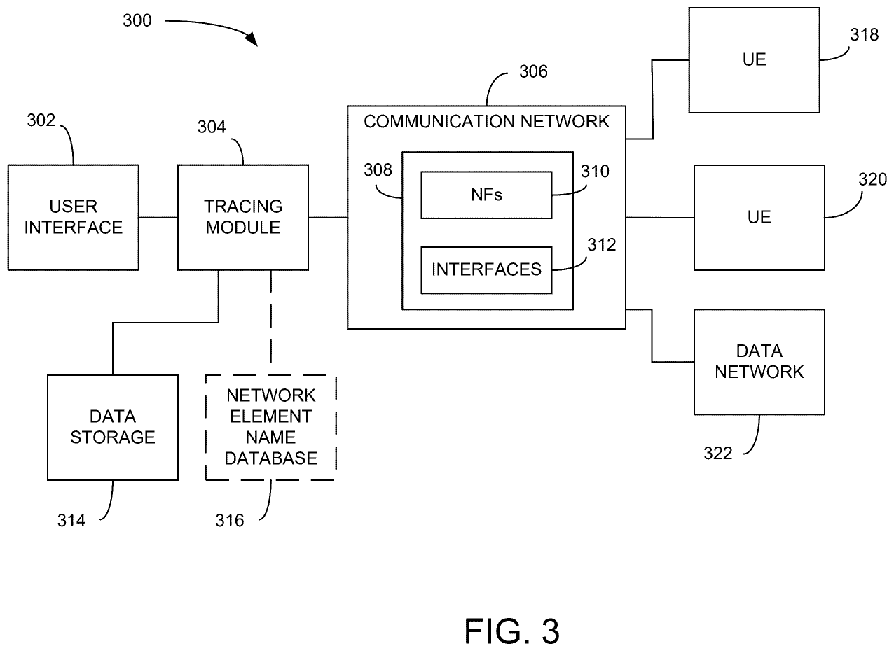

FIG. 3 is a block diagram of a system for performing a communication session trace using network element names in accordance with an embodiment. The system 300 can include a user interface 302, a tracing module 304, data storage 314, and an optional network element name database 316. In some embodiments, the user interface 302 and tracing module 304 can be associated with a CSP or carrier that provides communication services using a communication network 306 (e.g., communication network 100 shown in FIG. 1). The tracing module 304 can be configured to perform a communication session trace using network element names. For example, the tracing module 304 may be configured to perform a communication session trace for a communication session between a UE device (e.g., UE device 318 or UE device 320) and a data network 322 (e.g., the Internet) via the communication network 306 or for a communication session between two or more UE devices, e.g., UR device 318 and UE device 320, via the communication network 306. The user interface 302 can be configured to allow an operator or administrator of the communication network 306 to interact with the system 300, for example, to provide inputs to the tracing module 304 and to display outputs, for example, reports received from the tracing module 304. If an administrator (or operator) is tasked with investigating (e.g., debugging or troubleshooting) a problem with a communication session (e.g., a dropped call), the administrator may use user interface 302 to provide inputs to, for example, set up or initiate a communication session trace with the tracing module 304. The user interface 302 (e.g., inputs of a computer system 600 shown in FIG. 6) can include any suitable input devices and/or sensors that can be used to receive the user input such as a keyboard, a mouse, a touch screen, a microphone, a graphical user interface (GUI), a voice user interface (VOI), mechanical switches, buttons, knobs, etc. The user interface 302 can also include a display that can be used to display, for example, outputs such as reports generated by the tracing module 304. In some embodiments, the user interface 302 may be implemented on a computer system (e.g., computer system 600 discussed below with respect to FIG. 6).

The tracing module 304 can be configured to establish a communication session trace in one or more network elements 308 such as, for example, network functions (NFs) 310 and interfaces 312 (e.g., the network functions and interfaces as described above with respect to FIGS. 1 and 2), of the communication network 306 that are associated with the communication session. Once the communication session trace with the one or more network elements 308 (e.g., network functions 310 or interfaces 312) has been established, the tracing module 304 can collect or transfer trace data associated with the communication session. In some embodiments, the trace data can include signaling messages exchanged between the one or more network elements 308 associated with the communication session. Accordingly, the tracing module 304 can collect all the signaling messages for communication traffic between the network elements 308 that are associated with the communication session. The tracing module 304 can store the trace data in, for example, data storage 314 (e.g., memory 610 shown in FIG. 6).

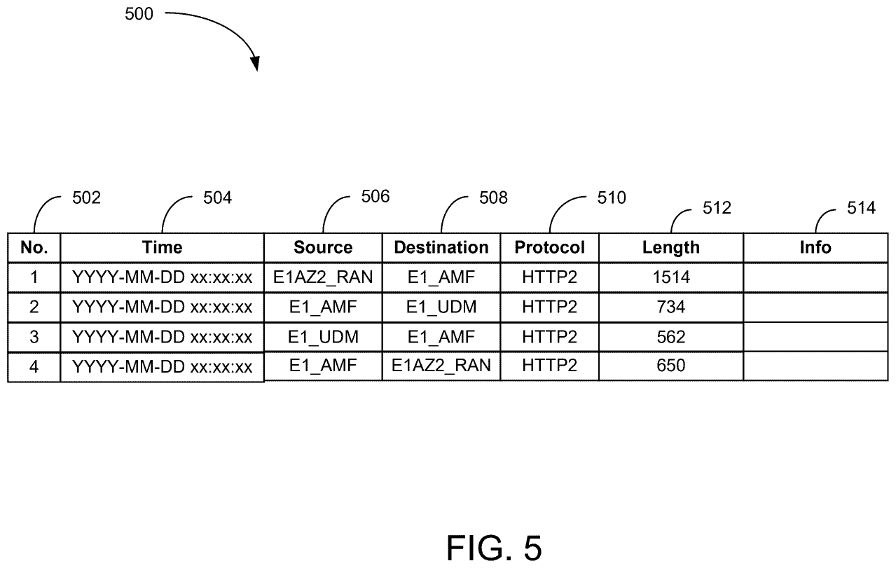

The tracing module 304 can advantageously be configured to identify the network element name (or hostname) of each network element in the trace data and associate the network element name with the appropriate signaling messages in the trace data. In some embodiments the network element name can indicate the type of network element as well as, for example, the region and availability zone of the communication network associated with the network element. In some embodiments, the network element name can specify what network element is sending a message or what network element is receiving a message. Example network element names (or hostnames) are illustrated in FIG. 5 which is described further below. In some embodiments, signaling messages collected with the trace can be configured to include a network element name within a packet in addition to the IP address assigned to the network element. Accordingly, a network element may send its own network element name (or hostname) along with its assigned IP address in the protocol level. For example, the network element name can be included as a parameter in a signaling message. In some embodiments, an optional network element name (or hostname) database 316 may be provided that includes both an IP address and a network element name for each network element in one or more communication networks. In some embodiments, if the network elements are from two or more communication networks, each communication network can be associated with a different CSP. The tracing module 304 can be configured to automatically access the network element name database 316 to search for an IP address of a network element provided in trace data and identify the associated network element name mapped to the IP address for the network element. In some embodiments, the network element name database 316 may be accessible by one or more CSPs which can each provide IP address and associate network element name for the network elements associated with the CSP's communication network. The network element name database 316 can be configured to be updated, for example, as a communication network changes size and additional network elements are added to the communication network.

The tracing module 304 can store the identified network element names with the trace data in, for example, data storage 314 (e.g., memory 610 shown in FIG. 6). In some embodiments, the tracing module 304 can also be configured to generate a report with the trace data including the identified network element names for the network elements (e.g., a source network element and a destination network element) associated with each signaling message. In some embodiments, the report can include the network element name but not the IP address for a network element. In some embodiments, the report can include both the network element name and the IP address for a network element. The report may be displayed on a display (e.g., a display of the user interface 302) for the administrator or operator to view. An example report is discussed further below with respect to FIG. 5.

In some embodiments, the tracing module 304, data storage 314, and network element name database 316 can be implemented on a computer system (e.g., computer system 600 discussed below with respect to FIG. 6). While FIG. 3 illustrates various components of the system for performing a communication session trace using network element names, other embodiments of the system can vary the arrangement, communication paths, and specific components of the system. In some embodiments, the system can include fewer, additional, or different components in different configurations than illustrated in FIG. 3.

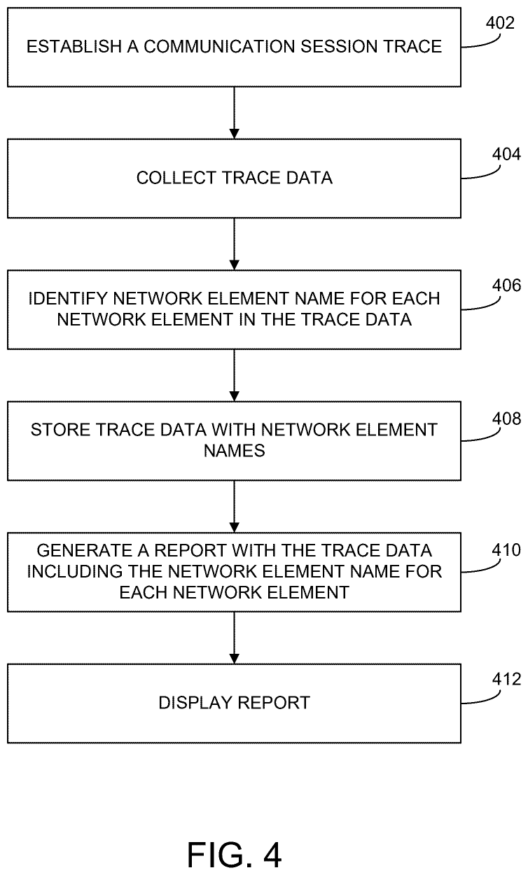

FIG. 4 illustrates a method for performing a communication session trace using network element names in accordance with an embodiment. The process illustrated in FIG. 4 is described as being carried out by the system in FIG. 3. However, in some examples, the process of FIG. 4 may be implemented by a different system. Although the blocks of the process are illustrated in a particular order, in some embodiments, one or more blocks may be executed in a different order than illustrated in FIG. 4, or may be bypassed.

At block 402, a communication session trace may be established or enabled using the tracing module 304. In some embodiments, the communication session trace can be established in one or more network elements 308 (e.g., network functions 310, interfaces 312) in a communication network 306 that are associated with the communication session. At block 404, trace data associated with the communication session can be collected, for example, using the tracing module 304. As mentioned, the trace data can include signaling messages exchanged between the one or more network elements 308 associated with the communication session. At block 406, the network element name of each network element 308 in the trace data can be identified using, for example, the tracing module 304. As mentioned, in some embodiments, signaling messages collected with the trace can be configured to include a network element name within a packet in addition to the IP address assigned to the network element. Accordingly, a network element may send its own network element name (or hostname) along with its assigned IP address in the protocol level. In some embodiments, an optional network element name (or hostname) database 316 may be provided that includes both an IP address and a network element name for each network element 308 in one or more communication networks. In one example, tracing module 304 can be configured to automatically access the network element name database 316 to search for an IP address of a network element 308 provided in trace data and identify the associated network element name mapped to the IP address for the network element.

At block 408, the trace data including the identified network element names for each network element 308 can be stored in data storage, for example, data storage 314. At block 410, a report can be generated, for example using the tracing module 304. The report can include the trace data including the identified network element names for each network element 308 associated with each signaling message. In some embodiments, the report can include the network element name but not the IP address for a network element. In some embodiments, the report can include both the network element name and the IP address for a network element. An example report is discussed further below with respect to FIG. 5. At block 412, the generated report may be displayed on a display (e.g., a display of the user interface 302) for an administrator or operator of the communication system 306 to view. For example, an administrator may view the collected trace data in the report, including the identified network element names for each network element 308, to try to identify where the issue is (e.g., which network element(s) 308) that caused a reported problem (e.g., a dropped call). In some embodiments, the generated report may also be stored in data storage 314.

FIG. 5 illustrates an example report with trace data and network element names in accordance with an embodiment. The report 500 generated by the tracing module 304 (shown in FIG. 3) can include various items from the collected trace data from a communication session trace. The example report 500 illustrated in FIG. 5 includes a number (e.g., 1-n) for each signaling message, a time 504 for each signaling message, a source network element 506 for each signaling message, a destination network element 508 for each signaling message, a protocol 510 for each signaling message, a length 52 for each signaling message, and other information 514 regarding the signaling message. As discussed above with respect to FIGS. 3 and 4, the source network element 506 and destination network element 508 can advantageously be identified by the network element name for the particular network element identified by the tracing module 304. As mentioned, in some embodiments, the network element name can indicate the type of network element as well as, for example, the region and availability zone of the communication network associated with the network element. In the example, report 500, for the first signaling message in the list, the source network element 506 has an example network element name “E1AZ2_RAN” indicating that it is a RAN in the East 1 region of the communication network and the availability zone 2 in the East 1 region. For the first signaling message, the destination network element 508 has an example network element name of “E1_AMF” indicating an AMF network function in the East 1 region of the communication network. For the second signaling message in the example report, the destination network element 506 has an example network element name of “E1_UDM” indicating a UDM network function in the East 1 region of the communication network. While FIG. 5 illustrates various examples of trace data, other types of trace data can be included in the collected trace data and a report generated by the tracing module (shown in FIG. 1). While FIG. 5 illustrates an example format of network element names for the various network elements, it should be understood that other formats may be used in various embodiments,

As mentioned above, various components of the disclosed system and method may be implemented on a computer system. FIG. 6 is a schematic block diagram of an example computer system in accordance with an embodiment. The computer system 600 (e.g., a server) may include one or more processor devices 602, a display 604, one or more inputs 606, one or more communication systems 608, and memory 610. In some embodiments, processor device(s) 602 can be any suitable hardware processor or combination of processors, such as a central processing unit (CPU), a graphics processing unit (GPU), a microprocessor, an application specific integrated circuit (ASIC), field programmable gate arrays (FPGA), digital signal processors (DSPs), etc. The processor device(s) 602 may include one or more processors, processor cores, processing elements, processor clusters, or other electronic processing units. Accordingly, a processing function described as being performed by the processor device(s) 602 may include multiple processors, processor cores, processing elements, processing clusters, etc. (of the processor device(s) 602) performing aspects or portions (sub-functions) of the processing function to complete the processing function. The one or more electronic processing units of the processor device(s) 602 may include one or more microprocessors, application-specific integrated circuits (“ASICs”), or other suitable electronic device for processing data. At least in some examples, the one or more electronic processing units of the processor device(s) 602 can be co-located physically (e.g., in the same facility, building, room, rack, or computing housing) as part of the computer system 600.

In some embodiments, display 604 can include any suitable display devices, such as a computer monitor, a touchscreen, a television, etc. In some embodiments, display 604 can be omitted. In some embodiments, inputs 606 can include any suitable input devices and/or sensors that can be used to receive user input, such as a keyboard, a mouse, a touchscreen, a microphone, a graphical user interface (GUI), a voice user interface (VOI), mechanical switches, buttons, knobs, etc. and allow a user or operator to interact with the system for performing a communication session trace using network element names. In some embodiments, inputs 606 can be omitted.

In some embodiments, communications system(s) 608 can include any suitable hardware, firmware, and/or software for communicating information over any suitable communication network (e.g., communication network 100 shown in FIG. 1). For example, communication system(s) 608 can include one or more transceivers, one or more communication chips and/or chip sets, etc. In a more particular example, communication system(s) 608 can include hardware, firmware and/or software that can be used to establish a Wi-Fi connection, a Bluetooth connection, a cellular connection an Ethernet connection, etc.

In some embodiments, memory 610 can include any suitable storage device or devices (e.g., one or more non-transitory computer readable media) that can be used to store instructions, values, etc., that can be used, for example, by processor device 602 to present content using display 604, to communicate with a communication network, to communicate with other computer systems, etc. Memory 610 can include any suitable volatile memory, non-volatile memory, storage, or any suitable combination thereof. For example, memory 610 can include RAM, ROM, EEPROM, one or more flash drives, one or more hard disks, one or more solid state drives, one or more optical drives, etc. The memory 610 may store data and/or instructions for use and execution by the computer system 600 (e.g., by the processor device(s) 602) to implement the functionality of, for example, a tracing module, a network element name database, a user interface, etc. described herein. For example, the memory 610 may include or store the user interface 302, the tracing module 304, data storage 314, and the network element name database 316 shown in FIG. 3. In some embodiments, the functionality described herein as being performed by the computer system 600 may be distributed among multiple computer systems, servers or devices (e.g., as part of a cloud service or cloud-computing environment).

In some examples, aspects of the technology, including computerized implementations of methods according to the technology, can be implemented as a system, method, apparatus, or article of manufacture using standard programming or engineering techniques to produce software, firmware, hardware, or any combination thereof to control a processor device (e.g., a serial or parallel general purpose or specialized processor chip, a single-or multi-core chip, a microprocessor, a field programmable gate array, any variety of combinations of a control unit, arithmetic logic unit, and processor register, and so on), a computer (e.g., a processor device operatively coupled to a memory), or another electronically operated controller to implement aspects detailed herein. Accordingly, for example, examples of the technology can be implemented as a set of instructions, tangibly embodies on a non-transitory computer-readable media, such that a processor device can implement the instructions based upon reading the instructions from the computer-readable media. Some examples of the technology can include (or utilize) a control device such as an automation device, a special purpose or general-purpose computer including various computer hardware, software, firmware, and so on. As specific examples, a control device can include a processor, a microcontroller, a field-programmable gate array, a programmable logic controller, logic gates, etc., and other types of components that are known in the art for implementation of appropriate functionality (e.g., memory, communication systems, power sources, user interfaces, and other inputs, etc.).

Certain operations of the methods according to the technology, or of systems executing those methods, can be represented schematically in the FIGs. or otherwise discussed herein. Unless otherwise specified or limited, representation in the FIGs. of particular operations in particular spatial order can not necessarily require those operations to be executed in a particular sequence corresponding to the particular spatial order. Correspondingly, certain operations represented in the FIGs., or otherwise disclosed herein, can be executed in different orders than are expressly illustrated, as appropriate for particular examples of the technology. Further, in some examples, certain operations can be executed in parallel, including by dedicated parallel processing devices, or separate computing devices configured to interoperate as part of a large system.

The present technology has been described in terms of one or more preferred embodiments, and it should be appreciated that many equivalents, alternatives, variations, and modifications, aside from those expressly stated, are possible and within the scope of the invention.

1. A system for performing a communication session trace using network element names, the system comprising:
a memory that stored one or more computer readable media that includes instructions; and
one or more processor devices configured to execute the instructions of the computer readable media to:
establish a communication session trace with one or more network elements of a communication network;
collect trace data from the one or more network elements of the communication network associated with the communication network trace;
identify a network element name for each network element in the trace data; and
generate a report comprising the trace data including the network element name for each network element.

2. The system according to claim 1, wherein the network element name for each network element identifies at least the type of network element.

3. The system according to claim 1, wherein the one or more processor devices are configured to further execute the instructions of the computer readable media to store the trace data with the identified network element name for each network element.

4. The system according to claim 1, wherein the trace data comprises one or more signaling messages and each network element is associated with one or more of the signaling messages.

5. The system according to claim 4, wherein the one or more processor devices are configured to further execute the instructions of the computer readable media to identify a network element name for each network element in the trace data based on an associated signaling message associated, wherein the signaling message is configured to include the network element name for the associated network element.

6. The system according to claim 1, wherein the one or more processor devices are configured to further execute the instructions of the computer readable media to identify a network element name for each network element in the trace data by accessing a network element name database, wherein the network element name database comprises a network element name and an IP address for a plurality of network elements.

7. The system according to claim 1, wherein each network element of the one or more network elements is one of a network function or an interface.

8. A method for performing a communication session trace using network element names, the method comprising:
establishing, using a processor device, a communication session trace with one or more network elements of a communication network;
collecting, using the processor device, trace data from the one or more network elements of the communication network associated with the communication network trace;
identifying, using the processor device, a network element name for each network element in the trace data; and
generating, using the processor device, a report comprising the trace data including the network element name for each network element.

9. The method according to claim 8, wherein the network element name for each network element identifies at least the type of network element.

10. The method according to claim 8, further comprising storing the trace data with the identified network element name for each network element.

11. The method according to claim 8, wherein the trace data comprises one or more signaling messages and each network element is associated with one or more of the signaling messages.

12. The method according to claim 11, wherein identifying a network element name for each network element in the trace data comprises identifying the network element name based on an associated signaling message, wherein the signaling message is configured to include the network element name for the associated network element.

13. The method according to claim 8, wherein identifying a network element name for each network element in the trace data comprises accessing a network element name database, wherein the network element name database comprises a network element name and an IP address for a plurality of network elements.

14. The method according to claim 8, wherein each network element of the one or more network elements is one of a network function or an interface.

15. A non-transitory, computer-readable medium storing instructions that, when executed by a processor perform a set of functions for performing a communication session trace using network element names, the set of functions comprising
establishing a communication session trace with one or more network elements of a communication network;
collecting trace data from the one or more network elements of the communication network associated with the communication network trace;
identifying a network element name for each network element in the trace data; and
generating a report comprising the trace data including the network element name for each network element.

16. The non-transitory computer-readable medium according to claim 15, wherein the network element name for each network element identifies at least the type of network element.

17. The non-transitory computer-readable medium according to claim 15, wherein the set of functions further comprises storing the trace data with the identified network element name for each network element.

18. The non-transitory computer-readable medium according to claim 15, wherein the trace data comprises one or more signaling messages and each network element is associated with one or more of the signaling messages.

19. The non-transitory computer-readable medium according to claim 18, wherein identifying a network element name for each network element in the trace data comprises identifying the network element name based on an associated signaling message, wherein the signaling message is configured to include the network element name for the associated network element.

20. The non-transitory, computer-readable medium according to claim 15, wherein identifying a network element name for each network element in the trace data comprises accessing a network element name database, wherein the network element name database comprises a network element name and am IP address for a plurality of network elements.
